(19) United States
(12) Patent Application Publication
(10) Pub. No.: US 2026/0180810 A1
(43) Pub. Date: Jun. 25, 2026

(54) PUBLICLY VERIFIABLE ENCRYPTED SIGNATURES

(71) Applicant: Coinbase, Inc., Oakland, CA (US)

(72) Inventor: Samuel Ranellucci, Montreal (CA)

(21) Appl. No.: 18/991,343

(22) Filed: Dec. 20, 2024

(51) Int. Cl. H04L 9/32; G06Q 20/38; H04L 9/00; H04L 9/08

(52) U.S. Cl. CPC H04L 9/3252; G06Q 20/3825; G06Q 20/3827; G06Q 20/3829; H04L 9/0825; H04L 9/50

(57) ABSTRACT

Methods, systems, and devices for data management are described. A signing device may cryptographically sign, using a private key, a message and output a signature including a random elliptic-curve element and a scalar. The signing device may encrypt the scalar using a publicly-verifiable encryption scheme and via an encryption key, where encrypting the scalar using the publicly-verifiable encryption scheme generates an encrypted scalar and a proof of encryption. The signing device may provide the random elliptic-curve element, the encrypted scalar, and the proof of encryption to a verifying device such that the verifying device may determine whether the random elliptic-curve element and the scalar form a valid signature for the message. The verifying device may determine, without knowing the scalar in decrypted form, whether applying the encrypted scalar to a first public value produces a second public value.

### FIELD OF TECHNOLOGY

The present disclosure relates generally to data management, including techniques for publicly verifiable encrypted signatures.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRA WINGS

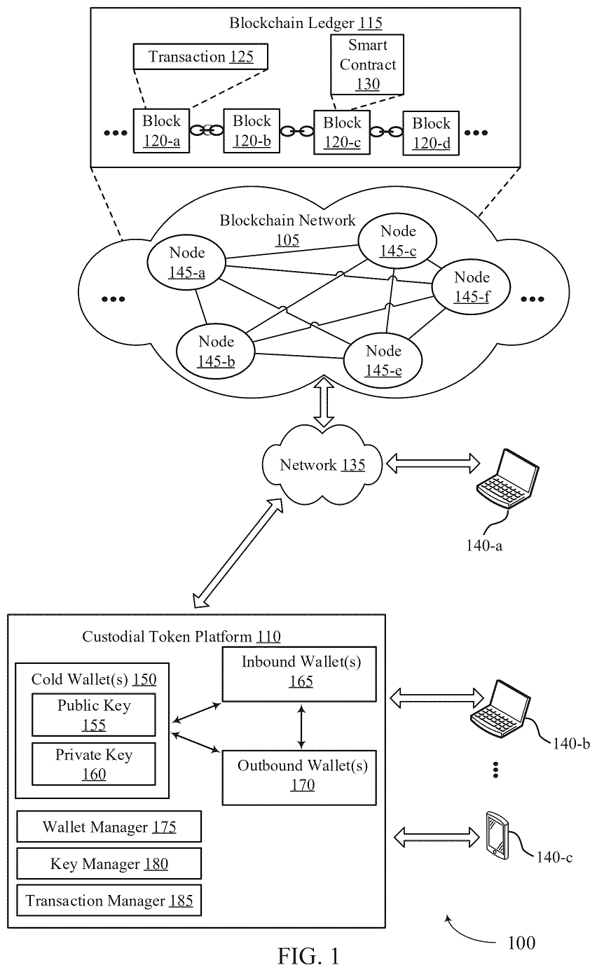

FIG. 1 illustrates an example of a computing environment that supports publicly verifiable encrypted signatures in accordance with aspects of the present disclosure.

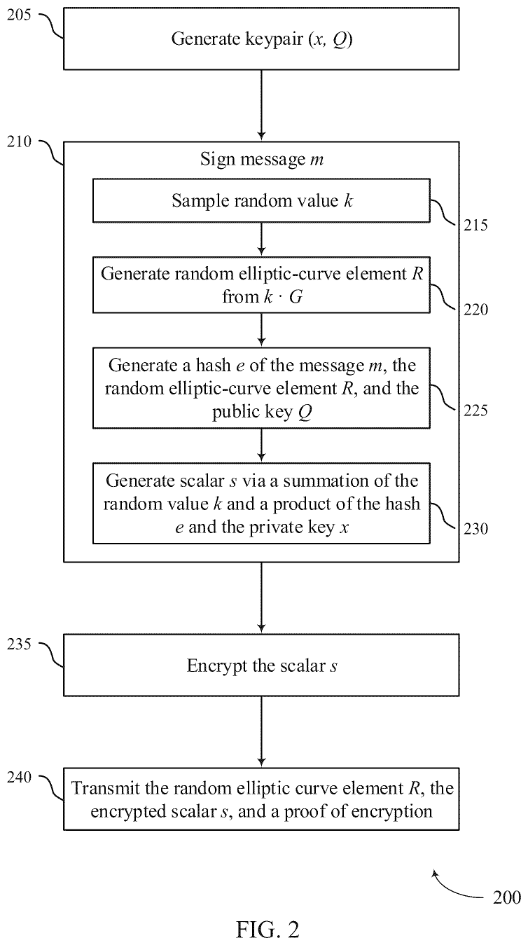

FIG. 2 through 5 show examples of flow diagrams that support publicly verifiable encrypted signatures in accordance with aspects of the present disclosure.

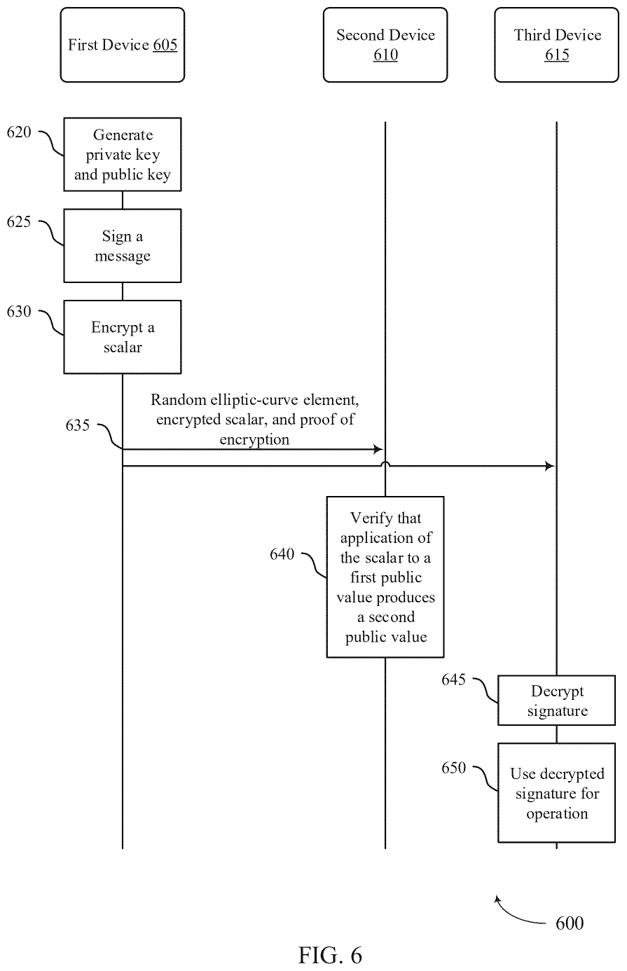

FIG. 6 shows an example of a process flow that supports publicly verifiable encrypted signatures in accordance with aspects of the present disclosure.

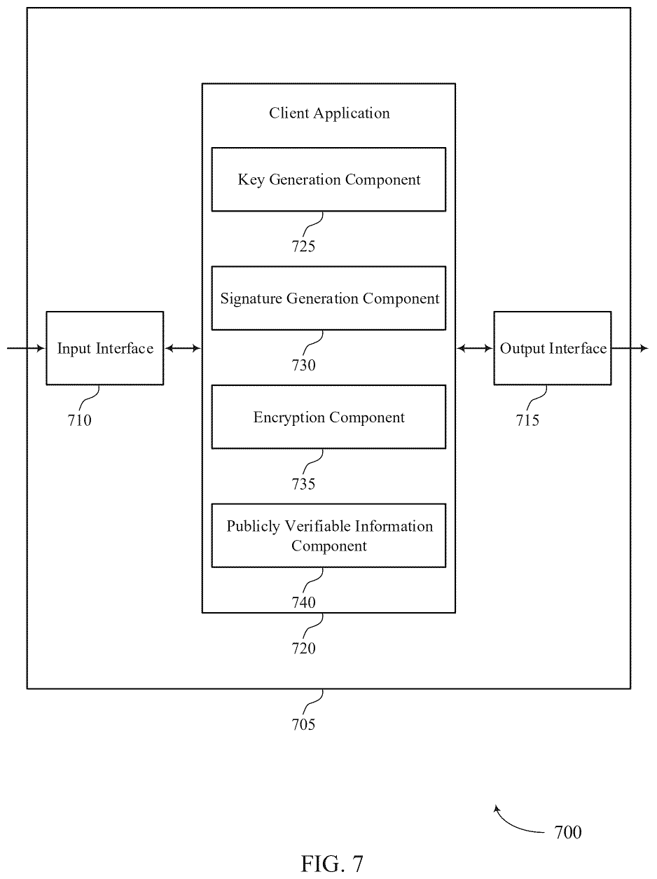

FIG. 7 shows a block diagram of an apparatus that supports publicly verifiable encrypted signatures in accordance with aspects of the present disclosure.

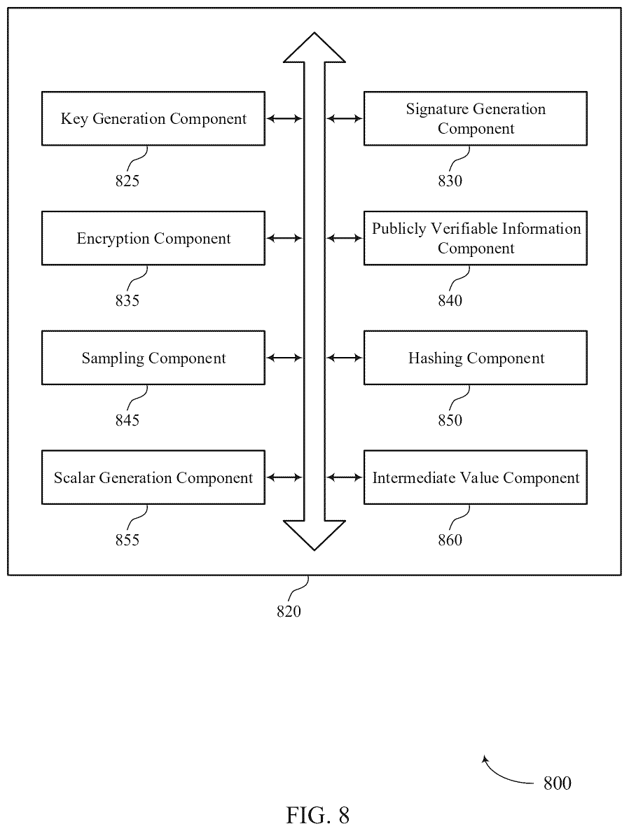

FIG. 8 shows a block diagram of a client application that supports publicly verifiable encrypted signatures in accordance with aspects of the present disclosure.

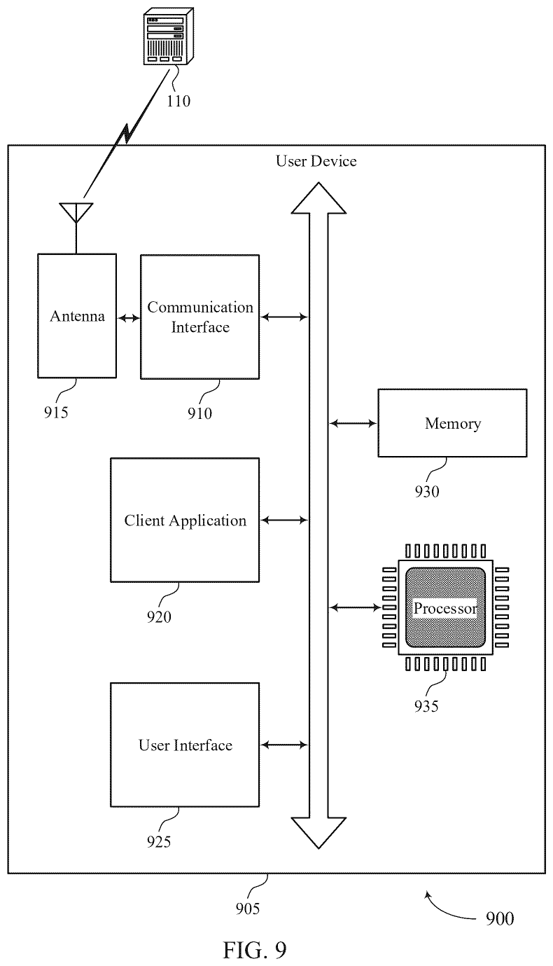

FIG. 9 shows a diagram of a system including a device that supports publicly verifiable encrypted signatures in accordance with aspects of the present disclosure.

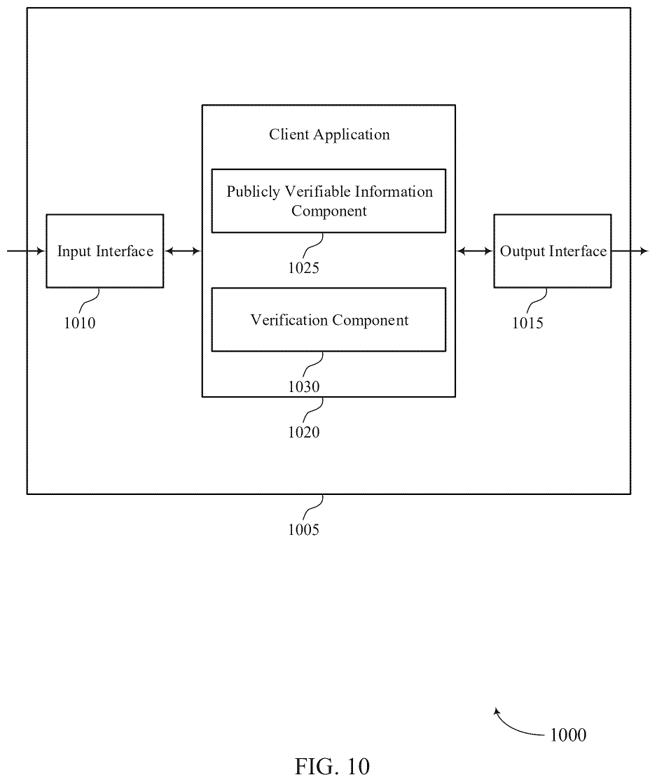

FIG. 10 shows a block diagram of an apparatus that supports publicly verifiable encrypted signatures in accordance with aspects of the present disclosure.

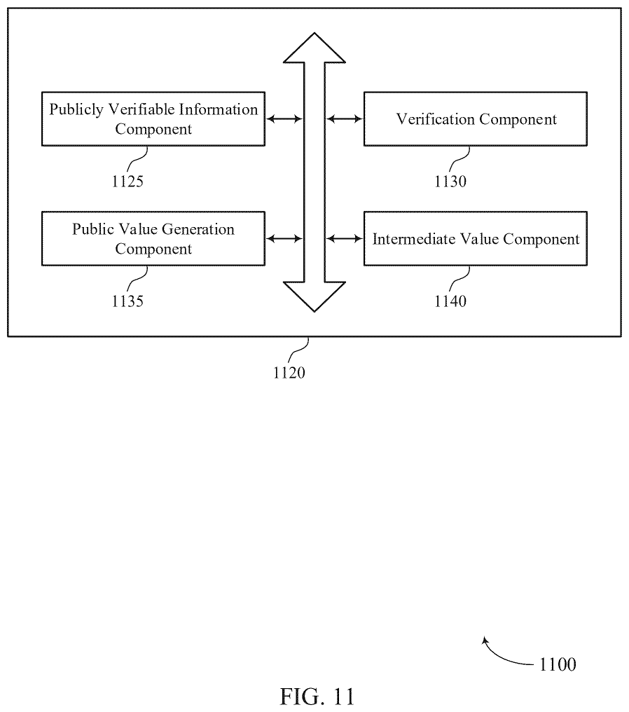

FIG. 11 shows a block diagram of a client application that supports publicly verifiable encrypted signatures in accordance with aspects of the present disclosure.

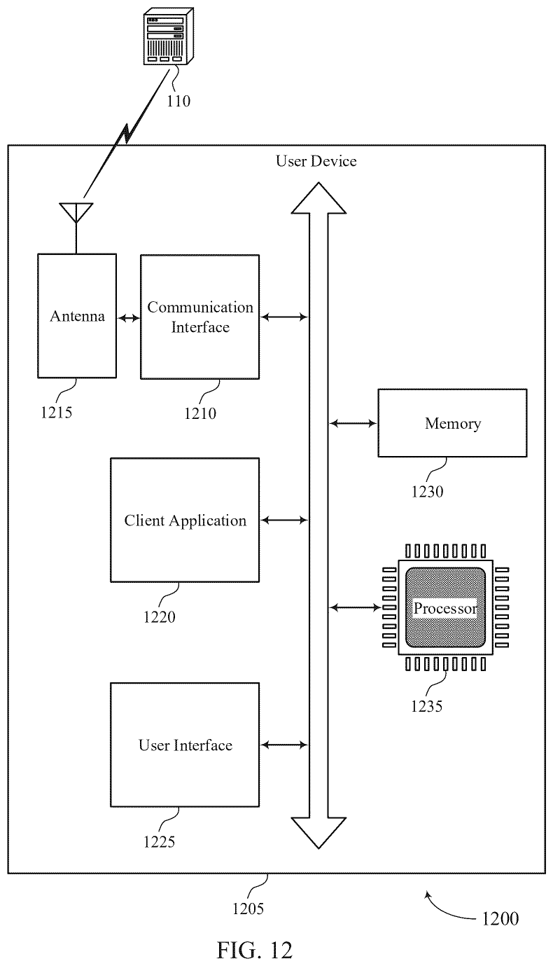

FIG. 12 shows a diagram of a system including a device that supports publicly verifiable encrypted signatures in accordance with aspects of the present disclosure.

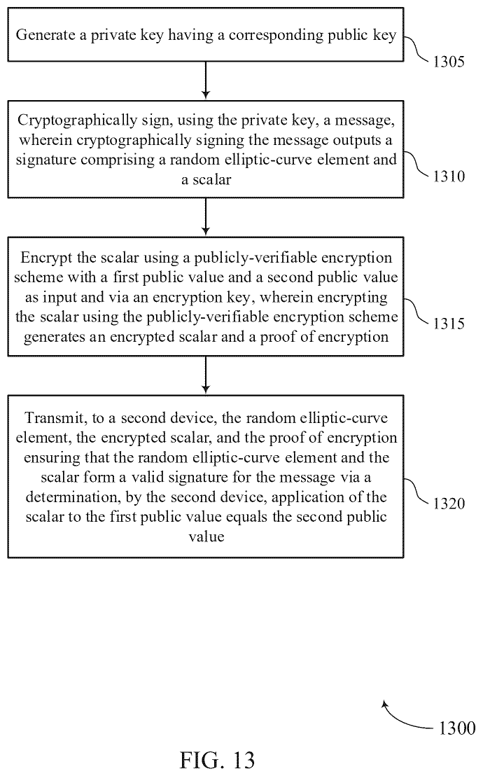

FIGS. 13 through 16 show flowcharts illustrating methods that support publicly verifiable encrypted signatures in accordance with aspects of the present disclosure.

### DETAILED DESCRIPTION

One or more parties having a secret, such as a secret value or a private key, may use publicly verifiable encryption to prove that the one or more parties possess the secret without revealing the secret itself. For example, publicly verifiable encryption may involve the one or more parties having the secret providing an encrypted version of the secret (e.g., or shares thereof) to a verifying party, where the verifying party may verify that the encrypted version corresponds to a public value associated with the secret without revealing the secret. Publicly verifiable encryption may be performed via various techniques. In one example, publicly verifiable encryption may involve the one or more parties having the secret providing individually encrypted parts of a secret to the verifying party, receiving a random challenge, and providing a threshold quantity of decrypted parts. For example, the one or more parties having the secret may provide enough decrypted parts of the secret to verify that the one or more parties possess the secret without revealing the secret itself. Generally, publicly verifiable encryption may involve an encryption scheme where a verifier can check that, for a publicly known E₁ and E₂, an encrypted value x is such that x applied to E₁ produces E₂. That is, the verifier may check that x·E₁=E₂.

In examples described herein, publicly verifiable encryption may be used to encrypt a signature of a message. For example, to encrypt the signature such that it is publicly verifiable, a signer may generate, using a signing key having a corresponding public key, a signature including a random elliptic-curve element and a scalar. The signer may encrypt the scalar using an encryption key having a corresponding decryption key (e.g., different from the signing key and the corresponding public key) and reveal the random elliptic-curve element and the encrypted scalar. By revealing the random elliptic-curve element and the encrypted scalar, the signer may enable other parties to verify that the random elliptic-curve element and the encrypted scalar form a valid signature for the message without revealing the signature itself. That is, because the signature is encrypted using a publicly verifiable encryption scheme, a verifying party may determine that the signature corresponds to the message without learning the signature itself. These and other techniques are described in further detail with respect to the figures.

FIG. 1 illustrates an example of a computing environment 100 that supports publicly verifiable encrypted signatures in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

Techniques described herein related to publicly verifiable encrypted signatures may be used in the context of the computing environment 100. For example, the custodial token platform 110 may provide a service in which a user having a private key (e.g., a signing key) signs a message and the signature is encrypted by the custodial token platform 110 via a publicly verifiable encryption scheme. The custodial token platform 110 (e.g., or the user via the custodial token platform 110) may provide the encrypted signature to a service external to the custodial token platform 110 that has a decryption key corresponding to the encryption key used by the custodial token platform 110 to encrypt the signature. Because the service has the decryption key (e.g., and not the custodial token platform 110), the service may control execution of the message on the blockchain network 105. As an example, the service may control when an operation on a blockchain network 105 (e.g., a transfer of a crypto token) occurs based on having access to the decryption key. In other words, the service may outsource cryptographic infrastructure used to generate the signature to another service while maintaining control over the use of such a signature.

In another example, techniques described herein related to publicly verifiable encrypted signatures may be used to pause a smart contract (e.g., the smart contract 130) on the blockchain network 105. For example, to pause a smart contract, a party may produce a signature. That is, the smart contract may be configured such that receipt of a signature generated via a given signing key causes the smart contract to pause (e.g., refrain from executing or being executable). However, producing a signature may involve parties coordinating in real-time, such as to ensure that the signature is valid (e.g., validation by multiple nodes on the blockchain network 105). To produce a signature relatively quickly and pause the smart contract in response to detection of an event (e.g., a security threat), the party having a signing key that is capable of pausing the smart contract may pre-generate a signature and store the signature in an encrypted form. The encrypted signature may, via publicly verifiable encryption, be verified by one or more nodes on the blockchain network 105 and, thus, usable to pause the smart contract after being decrypted. Put another way, the signing party may pre-generate and the nodes may pre-verify, before an event triggering pausing the smart contract occurs, an encrypted signature that may be decrypted to pause the smart contract. Because decrypting the signature occurs more quickly than obtaining the signature when keys or shares of keys are stored offline (e.g., due to fewer parties being involved, such as a single decrypting party as opposed to multiple parties having shares of a signing key), the party may be able to quickly pause the smart contract (e.g., to mitigate a security threat). In some examples, the parties that are needed to produce a signature to pause the smart contract may be targets for hackers. However, by using encrypted signatures, the signing keys of the parties required to produce the signatures may remain secure even if the decryption keys are leaked.

In some examples, techniques described herein may be used in a multi-party computation (MPC) scheme. For example, a signing key may be shared between multiple parties, where each party holds a key share of the signing key. The parties may individually generate and encrypt partial signatures. That is, a party may generate a partial signature using a key share of the signing key, and the entire signature may only be revealed based on obtaining, decrypting, and combining each encrypted partial signature generated by the multiple parties. In some examples, a threshold quantity of the parties may participate to perform operations using the signing key (e.g., a threshold signing scheme (TSS)). That is, a threshold quantity of parties of the multiple parties may generate and encrypt the partial signatures, or a decrypting party may obtain, decrypt, and combine a threshold quantity of partial signatures in order to perform an operation using a signature generated via the signing key (e.g., or shares thereof). Put another way, techniques described herein related to generating and encrypting a signature may also be applied to generating and encrypting a share (e.g., a portion, a part, less than all) of a signature.

FIG. 2 shows an example of a flow diagram 200 that supports publicly verifiable encrypted signatures in accordance with aspects of the present disclosure. The flow diagram 200 may be implemented by a signing party via a computing device, such as a computing device 140 as described with reference to FIG. 1. The flow diagram 200 may include operations performed in accordance with a signing algorithm. For example, the signing algorithm may include aspects of an Edwards-curve digital signature algorithm (EdDSA).

At 205, a signing party may generate a keypair. Generating the keypair may include sampling x ∈ Z_{q}. In other words, the signing party may select a random integer x from a set of integers (0, 1, 2, . . . q−1). The random integer x may be a private key, such as a signing key or a secret key (e.g., sk). Additionally, the signing party may generate a public key corresponding to the private key. The signing party may generate the public key Q as a dot product of the private key x and a generator function G. That is, the signing party may determine Q←x·G. The generator function G may be an element of a cyclic group that can be used to generate all the other elements of the group through exponentiation. For example, there may be a cyclic group of a prime order q for a scalar field (e.g., from where the key is sampled, Z_{q}), and the generator function G may be a generator of the cyclic group. That is, the generator function G may be an element of the cyclic group. Each element H in the cyclic group can be expressed as H=aG for some integer a where 0≤a<q, where aG denotes applying the group operation a−1 times to G (i.e., 3G=G+G+G).

At 210, the signing party may sign a message. For example, the signing party may sign a message m via the generated private key x. The signing party may perform the operations at 215 through 230 to generate the signature. As described in further detail herein, the message may be an example of a blockchain message or transaction that is to be communicated or broadcast to nodes of a blockchain network, such as the blockchain network 105 of FIG. 2. The blockchain network may verify the signature before adding the transaction to the blockchain ledger 115.

At 215, the signing party may sample a random value. For example, the signing party may sample k ∈ Z. In other words, the signing party may select a random integer k from the set of integers (0, 1, 2, . . . q−1). At 220, the signing party may generate a random elliptic-curve element. As used herein, a random elliptic-curve element may refer to a randomly chosen point on an elliptic curve that may be represented as (x, y), where (x, y) satisfies the equation defining a random elliptic-curve. The signing party may generate the random elliptic-curve element R as R←k. G. That is, the signing party may determine a dot product of the random integer k and the generator function G as the random elliptic-curve element.

At 225, the signing party may generate a hash. For example, the signing party may generate a hash of the message m (e.g., the message being signed), the random elliptic-curve element R, and the public key Q. Put another way, the signing party may generate H(m, R, Q), where a result of the hash may be represented as e. At 230, the signing party may generate a scalar. For example, the signing party may generate a scalar as a summation of the random integer k and the result of the hash e. That is, the signing party may determine a scalar s as s←k+e.

As a result of performing the operations at 215 through 230, the signing party generates a signature for the message using the private key. The generation of the signature may be represented as Signₓ(m)→(R,s), where the combination of the random elliptic-curve element R and the scalar s makes up the signature for the message.

At 235, the signing party may encrypt the scalar. For example, the signing party may encrypt the scalar using an encryption key. The encryption key may be different from the private key x generated at 205 and used to sign the message at 210. The signing party may encrypt the scalar such that the signature may be revealed by a party having a decryption key corresponding to the encryption key. That is, a decrypting party having the decryption key may decrypt and use the signature generated at 210.

At 240, the signing party may transmit or output results of the signing algorithm and the encryption. For example, the signing party may make a result of the signing algorithm and the encryption public, including the random elliptic-curve element R, the encrypted scalar s, and a proof of encryption based on encrypting the scalar at 235. As used herein, “transmitting” results of the signing algorithm and the encryption may refer to revealing publicly the results or transmitting the results to a verifying party.

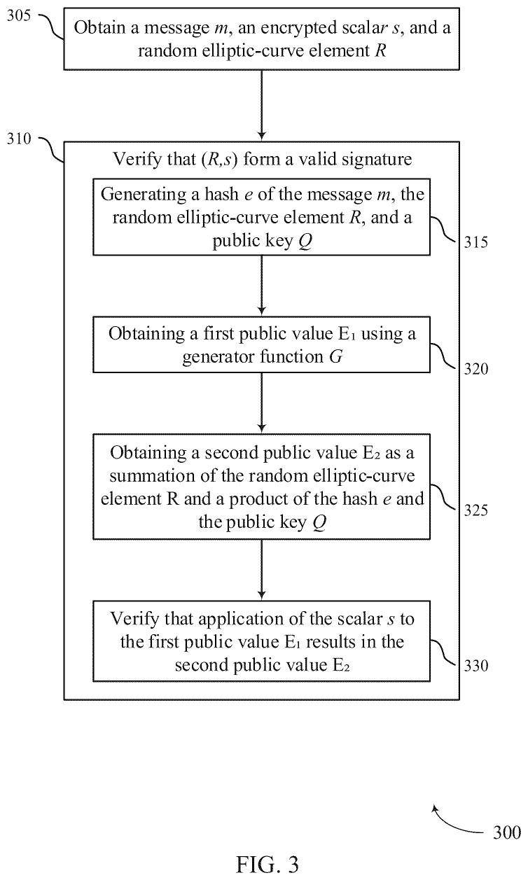

FIG. 3 shows an example of a flow diagram 300 that supports publicly verifiable encrypted signatures in accordance with aspects of the present disclosure. The flow diagram 300 may be implemented by a verifying party via a computing device, such as a computing device 140 as described with reference to FIG. 1. The flow diagram 300 may include operations performed in accordance with a verification algorithm. For example, the verification algorithm may include aspects of EdDSA.

At 305, the verifying party may obtain a message and an encrypted scalar. For example, the verifying party may obtain the message m, an encrypted scalar s, and a random elliptic-curve element R as a result of the signing party revealing the information at 240 of FIG. 2. Put another way, the verifying party may obtain ana combination of the encrypted scalar s and the random elliptic-curve element R. The verifying party may obtain the information at 305 such that it may verify that the random elliptic-curve element and the encrypted scalar form a valid signature for the message without learning the signature itself.

At 310, the verifying party may verify that the random elliptic-curve element and the encrypted scalar form a valid signature for the message without learning the signature itself. Verification may include the operations at 315 through 330. As used with reference to FIG. 3, “verifying” as performed by the verifying party may refer to a verification of whether the signature is accurately generated for the message. The verifying party, in accordance with a publicly-verifiable encryption scheme, may verify that the signature corresponds to the message without learning the signature. Verification by the verifying party described herein with reference to FIG. 3 may be understood as being different than verification of a signature performed by nodes of the blockchain network 105 as described with reference to FIG. 1.

At 315, the verifying party may generate a hash. For example, the verifying party may generate a hash of the message m, the random elliptic-curve element R, and the public key Q. That is, the verifying party may determine e←H(m, R, Q), where e is a result of the hash.

At 320, the verifying party may obtain a first public value. For example, the verifying party may obtain a first public value E₁ based on the generator function G. That is, the verifying party may determine E₁←G. At 325, the verifying party may obtain a second public value. For example, the verifying party may determine a second public value E₂ based on a summation of the random elliptic-curve element R with a product of the result of the hash e and the public key Q. That is, the verifying party may determine E₂←R+e. Q.

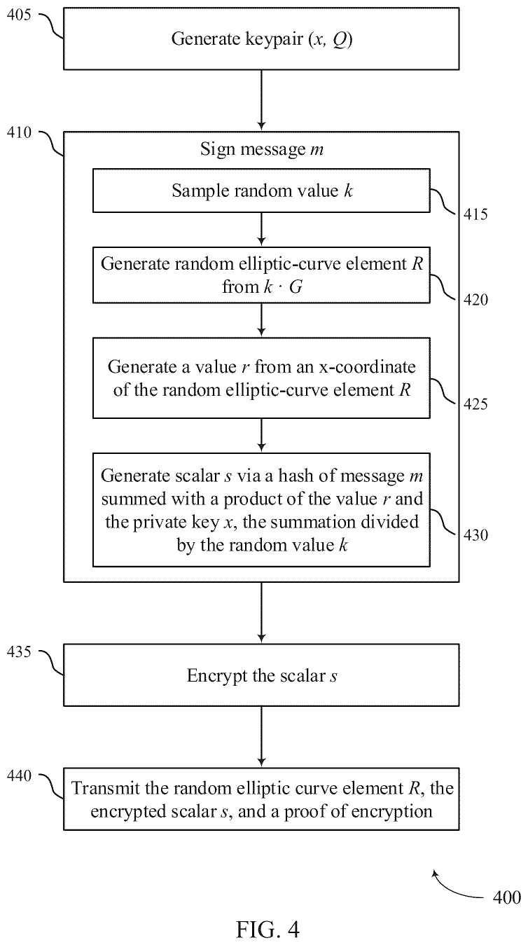

At 330, the verifying party may verify that application of the scalar to the first public value results in the second public value. For example, the verifying party may use a publicly-verifiable encryption scheme with the signing party to verify that the signing party possesses the signature without learning the signature itself. That is, the verifying party and the signing party may use publicly-verifiable encryption to guarantee that the signing party possesses a secret (e.g., the signature) without revealing the secret itself to the verifier. The publicly verifiable encryption scheme, in this example, may involve the signing party proving that they know a value s (e.g., the scalar) such that s·E₁=E₂. For example, the signing party may generate a proof that they know the value s, and the verifying party may check whether the proof is valid. FIG. 4 shows an example of a flow diagram 400 that supports publicly verifiable encrypted signatures in accordance with aspects of the present disclosure. The flow diagram 400 may be implemented by a signing party via a computing device, such as a computing device 140 as described with reference to FIG. 1. The flow diagram 400 may include operations performed in accordance with a signing algorithm. For example, the signing algorithm may include aspects of an elliptic curve digital signature algorithm (ECDSA).

At 405, the signing party may generate a keypair. Generating the keypair may include sampling x ∈ Za. In other words, the signing party may select a random integer x from a set of integers (0, 1, 2, . . . q−1). The random integer x may be a private key, such as a signing key or a secret key (e.g., sk). Additionally, the signing party may generate a public key corresponding to the private key. The signing party may generate the public key Q as a dot product of the private key x and a generator function G. That is, the signing party may determine Q←x·G.

At 410, the signing party may sign a message. For example, the signing party may sign a message m via the generated private key x. The signing party may perform the operations at 415 through 435 to generate the signature. As described in further detail herein, the message may be an example of a blockchain message or transaction that is to be communicated or broadcast to nodes of a blockchain network, such as the blockchain network 105 of FIG. 2. The blockchain network may verify the signature before adding the transaction to the blockchain ledger 115.

At 415, the signing party may sample a random value. For example, the signing party may sample k ∈ Z_{q}. In other words, the signing party may select a random integer k from the set of integers (0, 1, 2, . . . q−1). At 420, the signing party may generate a random elliptic-curve element. As used herein, a random elliptic-curve element may refer to a randomly chosen point on an elliptic curve that may be represented as (x, y), where (x, y) satisfies the equation defining a random elliptic-curve. The signing party may generate the random elliptic-curve element R as R←k· G. That is, the signing party may determine a dot product of the random integer k and the generator function G as the random elliptic-curve element.

At 425, the signing party may generate an intermediate value. For example, the signing party may generate an intermediate value r as an x coordinate of the random-elliptic curve element. That is, the signing party may determine the intermediate value r as r←R·x.

At 430, the signing party may generate a scalar. For example, the signing party may generate the scalar s based on the random value k, a hash of the message m, the intermediate value r, and the private key x. The signing party may generate the scalar s as k⁻¹(H(m)+r·x). That is, the signing party may generate the scalar s as a summation divided by the random value k, where the summation is of a hash of the message H(m) and a product of the intermediate value r with the private key x.

As a result of performing the operations at 415 through 430, the signing party generates a signature for the message using the private key. The generation of the signature may be represented as Signₓ(m)→(R, s), where the combination of the random elliptic-curve element R and the scalar s makes up the signature for the message.

At 435, the signing party may encrypt the scalar. For example, the signing party may encrypt the scalar using an encryption key. The encryption key may be different from the private key x generated at 405 and used to sign the message at 410. The signing party may encrypt the scalar such that the signature may be revealed by a party having a decryption key corresponding to the encryption key. That is, a decrypting party having the decryption key may decrypt and use the signature generated at 410.

At 440, the signing party may transmit results of the signing algorithm and the encryption. For example, the signing party may make a result of the signing algorithm and the encryption public, including the random elliptic-curve element R, the encrypted scalar s, and a proof of encryption based on encrypting the scalar at 435. As used herein, “transmitting” results of the signing algorithm and the encryption may refer to revealing publicly or transmitting the results to a verifying party.

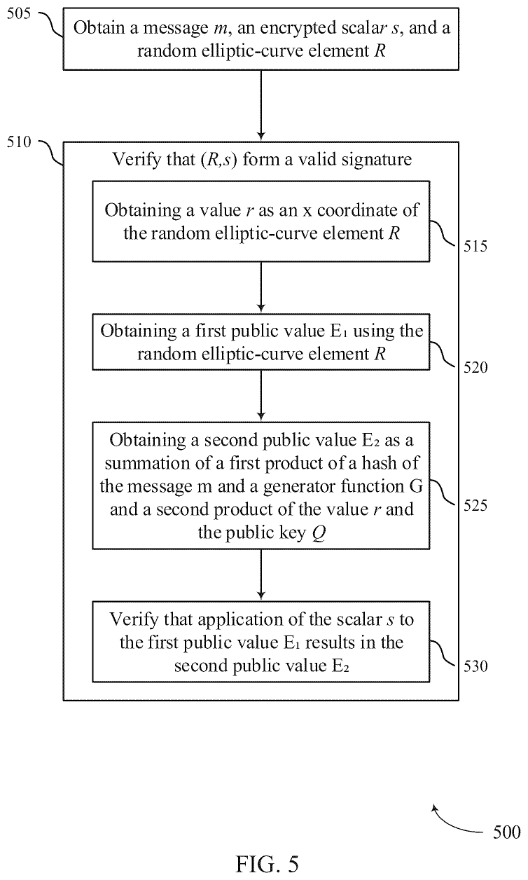

FIG. 5 shows an example of a flow diagram 500 that supports publicly verifiable encrypted signatures in accordance with aspects of the present disclosure. The flow diagram 500 may be implemented by a verifying party via a computing device, such as a computing device 140 as described with reference to FIG. 1. The flow diagram 500 may include operations performed in accordance with a verifying algorithm. For example, the verifying algorithm may include aspects of an ECDSA.

At 505, the verifying party may obtain a message and an encrypted scalar. For example, the verifying party may obtain the message m, an encrypted scalar s, and a random elliptic-curve element R as a result of the signing party revealing the information at 440 of FIG. 4. The verifying party may obtain the information at 505 such that it may verify that the random elliptic-curve element and the encrypted scalar form a valid signature for the message without learning the signature itself.

At 510, the verifying party may verify that the random elliptic-curve element and the encrypted scalar form a valid signature for the message without learning the signature itself. Verification may include the operations at 515 through 530. As used with reference to FIG. 5, “verifying” as performed by the verifying party may refer to a verification of whether the signature is accurately generated for the message. The verifying party, in accordance with a publicly-verifiable encryption scheme, may verify that the signature corresponds to the message without learning the signature. Verification by the verifying party described herein with reference to FIG. 5 may be understood as being different than verification of a signature performed by nodes of the blockchain network 105 as described with reference to FIG. 1.

At 515, the verifying party may obtain an intermediate value. For example, the verifying party may obtain the intermediate value r as an x coordinate of the random-elliptic curve element. That is, the verifying party may determine the intermediate value r as r←R.x.

At 520, the verifying party may obtain a first public value. For example, the verifying party may obtain the first public value E₁ as the random elliptic-curve element R. Put another way, the verifying party may determine the first public value E₁ as E₁←R. At 525, the verifying party may obtain a second public value. For example, the verifying party may obtain a second public value E₂ as a summation of a first product and a second product. The first product may be a product of a hash of the message H(m) and the generator function G. The second product may be a product of the intermediate value r and the public key Q. That is, the verifying party may obtain the second public value E₂ as E₂<H(m). G+r·Q. The second public value E₂ (e.g., H(m)·G+r·Q) can be reconstructed from R, m, and Q without knowing the scalar in decrypted form. That is, the verifying party may obtain the first public value and the second public value without decrypting (e.g., revealing) the scalar.

At 530, the verifying party may verify that application of the scalar to the first public value results in the second public value. For example, the verifying party may perform a publicly-verifiable encryption scheme with the signing party such that the signing party proves that it possesses the signature without the verifying party learning the signature itself. That is, the signing party may use publicly-verifiable encryption to prove that the signing party possesses a secret (e.g., the signature) without the verifying party learning the secret itself. The publicly verifiable encryption scheme, in this example, may involve the signing party proving that they know a value s (e.g., the scalar) such that s·E₁=E₂. For example, the signing party may generate a proof that they know the value s, and the verifying party may check whether the proof is valid.

FIG. 6 shows an example of a process flow 600 that supports publicly verifiable encrypted signatures in accordance with aspects of the present disclosure. The process flow 600 may implement or be implemented by the computing environment 100, the flow diagram 200, the flow diagram 300, the flow diagram 400, the flow diagram 500, or any combination thereof. For example, the process flow 600 may include a first device 605, a second device 610, and a third device 615 which may be examples of computing devices 140 as described with reference to FIG. 1. Additionally, or alternatively, the first device 605 and the second device 610 may be examples of signing devices or verifying devices, such as the signing devices and the verifying devices as described with reference to FIGS. 2 through 5. For example, the first device 605 may be an example of a signing device as described with reference to FIGS. 2 through 5, the second device 610 may be an example of a verifying device as described with reference to FIGS. 2 through 5, and the third device 615 may be an example of a decrypting device.

Alternative examples of the following may be implemented, where some operations are performed in a different order than described or are not performed at all. In some examples, operations may include additional features not mentioned below, or further operations may be added. Although the first device 605 and the second device 610 are shown performing the operations of the process flow 600, some aspects of some operations may also be performed by one or more other components.

At 620, the first device 605 may generate a private key and a public key. For example, the first device 605 may generate the private key and the public key in accordance with examples described herein, including with reference to the operations at 205 and at 405 of FIGS. 2 and 4, respectively. That is, the first device 605 may generate a private key having a corresponding public key. Generating the private key having the corresponding public key may include sampling a random value to generate the private key and generating the public key corresponding to the random value via the private key and a generator function.

At 625, the first device 605 may sign a message. For example, the first device 605 may sign a message in accordance with examples described herein, including with reference to the operations at 210 and at 410 of FIGS. 2 and 4, respectively. That is, the first device 605 may cryptographically sign, using the private key, a message, where cryptographically signing the message outputs a signature including a random elliptic-curve element and a scalar. The message may be an example of a blockchain transaction that is cryptographically signed via a private key of a blockchain wallet. That is, the message may be related to an operation on a blockchain network, such as the blockchain network 105 as described with reference to FIG. 1.

In some examples, such as in an EdDSA, signing the message may include sampling a random value, where the random elliptic-curve element is based on the random elliptic-curve element and a generator function. Additionally, signing the message may include generating a hash of a combination of the message, the random elliptic-curve element, and the public key. Finally, signing the message may include generating the scalar via a summation of the random value and a product of the hash and the private key. In other words, signing the message may include the operations at 215 through 230 of FIG. 2.

In another example, such as in an ECDSA, signing the message may include sampling a random value, where the random elliptic-curve element is based on the random value and a generator function. Additionally, signing the message may include determining an intermediate value based on an x coordinate of the random elliptic-curve element. Finally, signing the message may include generating the scalar as a summation divided by the random value, the summation being a summation of a hash of the message with a product of the third intermediate value and the private key. That is, signing the message may include the operations at 415 through 430 of FIG. 4.

In some examples, the first device 605 may cryptographically sign the message in accordance with a first signing algorithm, where the random elliptic-curve element and the scalar output by cryptographically signing the message are usable to generate a cryptographic signature in accordance with a second signing algorithm different than the first signing algorithm. Put another way, publicly verifiable encryption of signatures may involve a criteria that signing algorithms are equivalent. That is, values produced by one or the signing algorithms can be used to produce the signature that would be produced by another signing algorithm.

At 630, the first device 605 may encrypt the scalar. For example, the first device 605 may encrypt the scalar in accordance with examples described herein, including with reference to the operations at 235 and at 435 of FIGS. 2 and 4, respectively. That is, the first device 605 may encrypt the scalar using a publicly-verifiable encryption scheme with a first public value and a second public value as inputs and via an encryption key, where encrypting the scalar using the publicly-verifiable encryption scheme generates an encrypted scalar and a proof of encryption.

At 635, the first device 605 may output a random elliptic-curve element, the encrypted scalar, and a proof of encryption. For example, the first device 605 may reveal the random elliptic-curve element, the encrypted scalar, and the proof of encryption (e.g., to the second device 610 and the third device 615, among other devices). The first device 605 may output the information in accordance with examples described herein, including with reference to the operations at 240 and at 440 of FIGS. 2 and 4, respectively. For example, the first device 605 may transmit, to the second device 610 (e.g., and the third device 615), the random elliptic-curve element, the encrypted scalar, and the proof of encryption ensuring that the random elliptic-curve element and the scalar form a valid signature for the message via a determination, by the second device 610, that application of the scalar to a first public value equals a second public value.

At 640, the second device 610 may verify that application of the scalar to a first public value produces a second public value. The second device 610 may perform the verification in accordance with examples described herein, including with reference to the operations at 310 and at 510 of FIGS. 3 and 5, respectively. For example, the second device 610 may verify, using a publicly-verifiable encryption scheme, that the random elliptic-curve element and the encrypted scalar form a valid cryptographic signature by verifying that application of the encrypted scalar to a first public value equals a second public value. The first public value and the second public value may be generated based on the message, the random elliptic-curve element, and a public key corresponding to a private key used to generate the cryptographic signature.

In some examples, such as in an EdDSA, the verification may include generating the first public value using a generator function, generating the second public value using a hash of the message, the random elliptic-curve element, and the public key, and verifying that a product of the encrypted scalar and the first public value corresponds to the second public value. That is, the verification may include the operations at 320 through 330 of FIG. 3.

In another example, such as in an ECDSA, the verification may include determining a third intermediate value based on an x coordinate of the random elliptic-curve element. That is, the verification may include the operation at 515 of FIG. 5. In such examples, the verification may include obtaining the first public value as the random elliptic-curve element and the second public value as a summation of a first product of a hash of the message and a generator function and a second product of the third intermediate value and the public key. That is, the verification may include the operations at 520 and at 525 of FIG. 5. Additionally, the verification may include verifying that a product of the encrypted scalar and the random elliptic-curve element corresponds to the summation of the first product and the second product. For example, the verification may include the operation at 530 of FIG. 5.

In some examples, verifying the cryptographic signature may be in accordance with a first verification algorithm, where a cryptographic signature that fulfills the first verification algorithm is usable to generate a signature for a second verification algorithm different from the first verification algorithm. Put another way, publicly verifiable encryption of signatures may involve a criteria that verification algorithms are equivalent. That is, any signature that fulfills a verification algorithm can be used to produce a signature for another verification algorithm.

At 645, the third device 615 may decrypt the signature. For example, the third device 615 may decrypt the scalar to learn the signature using a decryption key corresponding to the encryption key used to encrypt the scalar at 630. After decrypting the signature, at 650, the third device 615 may use the decrypted signature for an operation. That is, the third device 615 may broadcast the signature of the message to a blockchain network such that one or more nodes of the blockchain network may validate the signature and execute an operation that is authorized by the signature, such as a cryptographic operation after the validation.

FIG. 7 shows a block diagram 700 of a device 705 that supports publicly verifiable encrypted signatures in accordance with aspects of the present disclosure. The device 705 may include an input interface 710, an output interface 715, and a client application 720. The device 705, or one or more components of the device 705 (e.g., the input interface 710, the output interface 715, the client application 720), may include at least one processor, which may be coupled with at least one memory, to support the described techniques. Each of these components may communicate, directly or indirectly, with one another (e.g., via one or more buses, communications links, communications interfaces, or any combination thereof).

The input interface 710 may manage input signaling for the user device 705. For example, the input interface 710 may receive input signaling (e.g., messages, packets, data, instructions, commands, transactions, or any other form of encoded information) from other systems or devices. The input interface 710 may send signaling corresponding to (e.g., representative of or otherwise based on) such input signaling to other components of the user device 705 for processing. For example, the input interface 710 may transmit such corresponding signaling to the client application 720 to support publicly verifiable encrypted signatures. In some cases, the input interface 710 may be a component of a communication interface 910 as described with reference to FIG. 9.

The output interface 715 may manage output signaling for the user device 705. For example, the output interface 715 may receive signaling from other components of the user device 705, such as the input interface 710, and may transmit such output signaling corresponding to (e.g., representative of or otherwise based on) such signaling to other systems or devices. In some cases, the output interface 715 may be a component of a communication interface 910 as described with reference to FIG. 9.

For example, the client application 720 may include a key generation component 725, a signature generation component 730, an encryption component 735, a publicly verifiable information component 740, or any combination thereof. In some examples, the client application 720, or various components thereof, may be configured to perform various operations (e.g., receiving, monitoring, transmitting) using or otherwise in cooperation with the input interface 710, the output interface 715, or both. For example, the client application 720 may receive information from the input interface 710, send information to the output interface 715, or be integrated in combination with the input interface 710, the output interface 715, or both to receive information, transmit information, or perform various other operations as described herein.

The key generation component 725 may be configured as or otherwise support a means for generating a private key having a corresponding public key. The signature generation component 730 may be configured as or otherwise support a means for cryptographically signing, using the private key, a message, wherein cryptographically signing the message outputs a signature comprising a random elliptic-curve element and a scalar. The encryption component 735 may be configured as or otherwise support a means for encrypting the scalar using a publicly-verifiable encryption scheme and via an encryption key, wherein encrypting the scalar using the publicly-verifiable encryption scheme generates an encrypted scalar and a proof of encryption. The publicly verifiable information component 740 may be configured as or otherwise support a means for transmitting, to a second device, the random elliptic-curve element, the encrypted scalar, and the proof of encryption ensuring that the random elliptic-curve element and the scalar form a valid signature for the message via a determination, by the second device, application of the scalar to a first public value equals a second public value.

FIG. 8 shows a block diagram 800 of a client application 820 that supports publicly verifiable encrypted signatures in accordance with aspects of the present disclosure. The client application 820 may be an example of aspects of a client application or a client application 720, or both, as described herein. The client application 820, or various components thereof, may be an example of means for performing various aspects of publicly verifiable encrypted signatures as described herein. For example, the client application 820 may include a key generation component 825, a signature generation component 830, an encryption component 835, a publicly verifiable information component 840, a sampling component 845, a hashing component 850, a scalar generation component 855, an intermediate value component 860, or any combination thereof. Each of these components may communicate, directly or indirectly, with one another (e.g., via one or more buses, communications links, communications interfaces, or any combination thereof).

The key generation component 825 may be configured as or otherwise support a means for generating a private key having a corresponding public key. The signature generation component 830 may be configured as or otherwise support a means for cryptographically signing, using the private key, a message, wherein cryptographically signing the message outputs a signature comprising a random elliptic-curve element and a scalar. The encryption component 835 may be configured as or otherwise support a means for encrypting the scalar using a publicly-verifiable encryption scheme and via an encryption key, wherein encrypting the scalar using the publicly-verifiable encryption scheme generates an encrypted scalar and a proof of encryption. The publicly verifiable information component 840 may be configured as or otherwise support a means for transmitting, to a second device, the random elliptic-curve element, the encrypted scalar, and the proof of encryption ensuring that the random elliptic-curve element and the scalar form a valid signature for the message via a determination, by the second device, application of the scalar to a first public value equals a second public value.

In some examples, to support cryptographically signing the message, the signature generation component 830 may be configured as or otherwise support a means for cryptographically signing the message in accordance with a first signing algorithm, wherein the random elliptic-curve element and the scalar output by cryptographically signing the message are usable to generate a cryptographic signature in accordance with a second signing algorithm different than the first signing algorithm.

In some examples, to support generating the private key having the corresponding public key, the key generation component 825 may be configured as or otherwise support a means for sampling a random value to generate the private key. In some examples, to support generating the private key having the corresponding public key, the key generation component 825 may be configured as or otherwise support a means for generating the public key corresponding to the random value via the private key and a generator function.

In some examples, the sampling component 845 may be configured as or otherwise support a means for sampling a random value, wherein the random elliptic-curve element is based at least in part on the random value and a generator function. In some examples, the hashing component 850 may be configured as or otherwise support a means for generating a hash of a combination of the message, the random elliptic-curve element, and the public key. In some examples, the scalar generation component 855 may be configured as or otherwise support a means for generating the scalar via a summation of the random value and a product of the hash and the private key.

In some examples, the first public value comprises the generator function and. In some examples, the second public value comprises a sum of the random elliptic-curve element and a product of the hash and the public key.

In some examples, the sampling component 845 may be configured as or otherwise support a means for sampling a random value, wherein the random elliptic-curve element is based at least in part on the random value and a generator function. In some examples, the intermediate value component 860 may be configured as or otherwise support a means for determining a third intermediate value based at least in part on an x coordinate of the random elliptic-curve element. In some examples, the scalar generation component 855 may be configured as or otherwise support a means for generating the scalar as a summation divided by the random value, the summation being a summation of a hash of the message with a product of the third intermediate value and the private key.

In some examples, the first public value and the second public value are generated using the message and the random elliptic-curve element.

In some examples, the first public value and the second public value are unassociated with the scalar.

In some examples, the first public value and the second public value comprise intermediate values that are obtained via a portion of a verification algorithm performed by the second device.

In some examples, the message comprises a blockchain transaction that is cryptographically signed via the private key of a blockchain wallet.

FIG. 9 shows a diagram of a system 900 including a device 905 that supports publicly verifiable encrypted signatures in accordance with aspects of the present disclosure. The device 905 may be an example of or include components of a device 705 as described herein. The device 905 may include components for bi-directional voice and data communications including components for transmitting and receiving communications, such as a client application 920, a communication interface 910, one or more antennas 915, a user interface component 925, at least one memory 930, and at least one processor 935. Each of these components may communicate, directly or indirectly, with one another (e.g., via one or more buses, communications links, communications interfaces, or any combination thereof).

The communication interface 910 may manage input and output signals for the device 905 via the antenna 915. For example, the communication interface 910 may enable the user device 905 to exchange information (e.g., input information, output information, or both) with other systems or devices, such as custodial token platform 110 (e.g., supported by one or more servers), via one or more wired or wireless communication links. The communication interface 910 may also utilize or interact with antenna 915 to support communication with other systems or devices. In some cases, the communication interface 910 may represent a physical connection or port to an external peripheral, such as a hardware wallet device. In some cases, the communication interface 910 may utilize an operating system such as iOS®, ANDROID®, MS-DOS®, MS-WINDOWS®, OS/2®, UNIX®, LINUX®, or another known operating system. The communication interface 910 may be implemented as part of the processor 935.

In some cases, the device 905 may include a single antenna 915. However, in some other cases, the device 905 may have more than one antenna 915, which may be capable of concurrently transmitting or receiving multiple wireless transmissions. The communication interface 910 may communicate bi-directionally, via the one or more antennas 915, wired, or wireless links as described herein. For example, the communication interface 910 may represent a wireless transceiver and may communicate bi-directionally with another wireless transceiver. The communication interface 910 may also include a modem to modulate the packets, to provide the modulated packets to one or more antennas 915 for transmission, and to demodulate packets received from the one or more antennas 915.

The user interface component 925 may represent a keyboard, a mouse, a touchscreen, a microphone, or a similar device or component. In some cases, a user may interact with the user interface component 925. In other cases, the user interface component 925 may operate automatically without user interaction. The user interface component 925 may display or output information such as information received from other systems or devices or information to be transmitted to other systems or devices.

The memory 930 may include RAM and ROM. The memory 930 may store computer-readable, computer-executable software including instructions that, when executed, cause at least one processor 935 to perform various functions described herein. In some cases, the memory 930 may contain, among other things, a BIOS which may control basic hardware or software operation such as the interaction with peripheral components or devices. The memory 930 may be an example of a single memory or multiple memories. For example, the user device 905 may include one or more memories 930.

The processor 935 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 935 may be configured to operate a memory array using a memory controller. In other cases, a memory controller may be integrated into the processor 935. The processor 935 may be configured to execute computer-readable instructions stored in at least one memory 930 to perform various functions (e.g., functions or tasks supporting a method and system for publicly verifiable encrypted signatures). Though a single processor 935 is depicted in the example of FIG. 9, it is to be understood that the user device 905 may include any quantity of one or more of processors 935 and that a group of processors 935 may collectively perform one or more functions ascribed herein to a processor, such as the processor 935. The processor 935 may be an example of a single processor or multiple processors. For example, the device 905 may include one or more processors 935.

For example, the client application 920 may be configured as or otherwise support a means for generating a private key having a corresponding public key. The client application 920 may be configured as or otherwise support a means for cryptographically signing, using the private key, a message, wherein cryptographically signing the message outputs a signature comprising a random elliptic-curve element and a scalar. The client application 920 may be configured as or otherwise support a means for encrypting the scalar using a publicly-verifiable encryption scheme and via an encryption key, wherein encrypting the scalar using the publicly-verifiable encryption scheme generates an encrypted scalar and a proof of encryption. The client application 920 may be configured as or otherwise support a means for transmitting, to a second device, the random elliptic-curve element, the encrypted scalar, and the proof of encryption ensuring that the random elliptic-curve element and the scalar form a valid signature for the message via a determination, by the second device, application of the scalar to a first public value equals a second public value.

By including or configuring the client application 920 in accordance with examples as described herein, the device 905 may support techniques for improved security via publicly verifiable encrypted signatures. For example, by supporting verification of signatures when in an encrypted form, examples described herein may support improved security for a signing key against availability by an untrusted party of a key used to verify the signature (e.g., a public key corresponding to a private key used to generate the signature).

The client application 920 may include an application (e.g., “app”), program, software, extension, or other component which is configured to facilitate communications with a custodial token platform 110 on a server, one or more nodes of a blockchain network 105, other user devices 905, and other devices or systems. For example, the client application 920 may be an application executable on the user device 905, and the client application 920 may be configured to receive data from a custodial token platform 110, transmit data to the custodial token platform 110, process such data, and cause presentation of such data to a user via a user interface component 925. The client application 920 may be an example of a wallet application, a wallet device, or both, and may be associated with a wallet address and may access or use a private key to sign messages to facilitate transfer of crypto tokens, messages, transactions, or the like via a blockchain distributed data store.

FIG. 10 shows a block diagram 1000 of a device 1005 that supports publicly verifiable encrypted signatures in accordance with aspects of the present disclosure. The device 1005 may include an input interface 1010, an output interface 1015, and a client application 1020. The device 1005, or one or more components of the device 1005 (e.g., the input interface 1010, the output interface 1015, the client application 1020), may include at least one processor, which may be coupled with at least one memory, to support the described techniques. Each of these components may communicate, directly or indirectly, with one another (e.g., via one or more buses, communications links, communications interfaces, or any combination thereof).

The input interface 1010 may manage input signaling for the user device 1005. For example, the input interface 1010 may receive input signaling (e.g., messages, packets, data, instructions, commands, transactions, or any other form of encoded information) from other systems or devices. The input interface 1010 may send signaling corresponding to (e.g., representative of or otherwise based on) such input signaling to other components of the user device 1005 for processing. For example, the input interface 1010 may transmit such corresponding signaling to the client application 1020 to support publicly verifiable encrypted signatures. In some cases, the input interface 1010 may be a component of a 1210 as described with reference to FIG. 12.

The output interface 1015 may manage output signaling for the user device 1005. For example, the output interface 1015 may receive signaling from other components of the user device 1005, such as the input interface 1010, and may transmit such output signaling corresponding to (e.g., representative of or otherwise based on) such signaling to other systems or devices. In some cases, the output interface 1015 may be a component of a communication interface 1210 as described with reference to FIG. 12.

For example, the client application 1020 may include a publicly verifiable information component 1025 a verification component 1030, or any combination thereof. In some examples, the client application 1020, or various components thereof, may be configured to perform various operations (e.g., receiving, monitoring, transmitting) using or otherwise in cooperation with the input interface 1010, the output interface 1015, or both. For example, the client application 1020 may receive information from the input interface 1010, send information to the output interface 1015, or be integrated in combination with the input interface 1010, the output interface 1015, or both to receive information, transmit information, or perform various other operations as described herein.

The publicly verifiable information component 1025 may be configured as or otherwise support a means for obtaining, from a first device and in accordance with the publicly verifiable encryption of a cryptographic signature of a message, a random elliptic-curve element, an encrypted scalar, and a proof of encryption. The verification component 1030 may be configured as or otherwise support a means for verifying, using a publicly-verifiable encryption scheme, that the random elliptic-curve element and the encrypted signature form a valid cryptographic signature by verifying that application of the encrypted scalar to a first public value equals a second public value, wherein: the first public value and the second public value are generated based at least in part on the message, the random elliptic-curve element, and a public key corresponding to a private key used to generate the cryptographic signature.

FIG. 11 shows a block diagram 1100 of a client application 1120 that supports publicly verifiable encrypted signatures in accordance with aspects of the present disclosure. The client application 1120 may be an example of aspects of a client application or a client application 1020, or both, as described herein. The client application 1120, or various components thereof, may be an example of means for performing various aspects of publicly verifiable encrypted signatures as described herein. For example, the client application 1120 may include a publicly verifiable information component 1125, a verification component 1130, a public value generation component 1135, an intermediate value component 1140, or any combination thereof. Each of these components may communicate, directly or indirectly, with one another (e.g., via one or more buses, communications links, communications interfaces, or any combination thereof).

The publicly verifiable information component 1125 may be configured as or otherwise support a means for obtaining, from a first device and in accordance with the publicly verifiable encryption of a cryptographic signature of a message, a random elliptic-curve element, an encrypted scalar, and a proof of encryption. The verification component 1130 may be configured as or otherwise support a means for verifying, using a publicly-verifiable encryption scheme, that the random elliptic-curve element and the encrypted signature form a valid cryptographic signature by verifying that application of the encrypted scalar to a first public value equals a second public value, wherein: the first public value and the second public value are generated based at least in part on the message, the random elliptic-curve element, and a public key corresponding to a private key used to generate the cryptographic signature.

In some examples, to support verifying the cryptographic signature, the verification component 1130 may be configured as or otherwise support a means for verifying the cryptographic signature in accordance with a first verification algorithm, wherein a cryptographic signature that fulfills the first verification algorithm is usable to generate a signature for a second verification algorithm different than the first verification algorithm.

In some examples, to support verifying the cryptographic signature, the public value generation component 1135 may be configured as or otherwise support a means for generating the first public value using a generator function. In some examples, to support verifying the cryptographic signature, the public value generation component 1135 may be configured as or otherwise support a means for generating the second public value using a hash of the message, the random elliptic-curve element, and the public key. In some examples, to support verifying the cryptographic signature, the verification component 1130 may be configured as or otherwise support a means for verifying that a product of the encrypted scalar and the first public value corresponds to the second public value.

In some examples, the intermediate value component 1140 may be configured as or otherwise support a means for determining a third intermediate value based at least in part on an x coordinate of the random elliptic-curve element.

In some examples, the first public value includes the random elliptic-curve element, and the second public value includes a summation of a first product of a hash of the message and a generator function and a second product of the third intermediate value and the public key. In such examples, to support verifying the cryptographic signature, the verification component 1130 may be configured as or otherwise support a means for verifying that a product of the encrypted scalar and the random elliptic-curve element corresponds to the summation of the first product and the second product.

In some examples, the first public value and the second public value are generated using the message and the random elliptic-curve element.

In some examples, the first public value and the second public value are unassociated with the scalar.

In some examples, the first public value and the second public value comprise intermediate values that are obtained via a portion of a verification algorithm and without the scalar. In some examples, verifying the cryptographic signature is in accordance with the verification algorithm.

In some examples, the message comprises a blockchain transaction that is cryptographically signed via the private key of a blockchain wallet.

FIG. 12 shows a diagram of a system 1200 including a device 1205 that supports publicly verifiable encrypted signatures in accordance with aspects of the present disclosure. The device 1205 may be an example of or include components of a device 1005 as described herein. The device 1205 may include components for bi-directional voice and data communications including components for transmitting and receiving communications, such as a client application 1220, a communication interface 1210, one or more antennas 1215, a user interface component 1225, at least one memory 1230, and at least one processor 1235. Each of these components may communicate, directly or indirectly, with one another (e.g., via one or more buses, communications links, communications interfaces, or any combination thereof).

The communication interface 1210 may manage input and output signals for the device 1205 via the antenna 1215. For example, the communication interface 1210 may enable the user device 1205 to exchange information (e.g., input information, output information, or both) with other systems or devices, such as custodial token platform 110 (e.g., supported by one or more servers), via one or more wired or wireless communication links. The communication interface 1210 may also utilize or interact with antenna 1215 to support communication with other systems or devices. In some cases, the communication interface 1210 may represent a physical connection or port to an external peripheral, such as a hardware wallet device. In some cases, the communication interface 1210 may utilize an operating system such as iOS®, ANDROID®, MS-DOS®, MS-WINDOWS®, OS/2®, UNIX®, LINUX®, or another known operating system. The communication interface 1210 may be implemented as part of the processor 1235.

In some cases, the device 1205 may include a single antenna 1215. However, in some other cases, the device 1205 may have more than one antenna 1215, which may be capable of concurrently transmitting or receiving multiple wireless transmissions. The communication interface 1210 may communicate bi-directionally, via the one or more antennas 1215, wired, or wireless links as described herein. For example, the communication interface 1210 may represent a wireless transceiver and may communicate bi-directionally with another wireless transceiver. The communication interface 1210 may also include a modem to modulate the packets, to provide the modulated packets to one or more antennas 1215 for transmission, and to demodulate packets received from the one or more antennas 1215.

The user interface component 1225 may represent a keyboard, a mouse, a touchscreen, a microphone, or a similar device or component. In some cases, a user may interact with the user interface component 1225. In other cases, the user interface component 1225 may operate automatically without user interaction. The user interface component 1225 may display or output information such as information received from other systems or devices or information to be transmitted to other systems or devices.

The memory 1230 may include RAM and ROM. The memory 1230 may store computer-readable, computer-executable software including instructions that, when executed, cause at least one processor 1235 to perform various functions described herein. In some cases, the memory 1230 may contain, among other things, a BIOS which may control basic hardware or software operation such as the interaction with peripheral components or devices. The memory 1230 may be an example of a single memory or multiple memories. For example, the user device 1205 may include one or more memories 1230.

The processor 1235 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1235 may be configured to operate a memory array using a memory controller. In other cases, a memory controller may be integrated into the processor 1235. The processor 1235 may be configured to execute computer-readable instructions stored in at least one memory 1230 to perform various functions (e.g., functions or tasks supporting a method and system for publicly verifiable encrypted signatures). Though a single processor 1235 is depicted in the example of FIG. 12, it is to be understood that the user device 1205 may include any quantity of one or more of processors 1235 and that a group of processors 1235 may collectively perform one or more functions ascribed herein to a processor, such as the processor 1235. The processor 1235 may be an example of a single processor or multiple processors. For example, the device 1205 may include one or more processors 1235.

For example, the client application 1220 may be configured as or otherwise support a means for obtaining, from a first device and in accordance with the publicly verifiable encryption of a cryptographic signature of a message, a random elliptic-curve element, an encrypted scalar, and a proof of encryption. The client application 1220 may be configured as or otherwise support a means for verifying, using a publicly-verifiable encryption scheme, that the random elliptic-curve element and the encrypted signature form a valid cryptographic signature by verifying that application of the encrypted scalar to a first public value equals a second public value, wherein: the first public value and the second public value are generated based at least in part on the message, the random elliptic-curve element, and a public key corresponding to a private key used to generate the cryptographic signature.

By including or configuring the client application 1220 in accordance with examples as described herein, the device 1205 may support techniques for improved security related to enabling verification of signatures without revealing the signature itself. For example, the device 1205 may verify that the random elliptic-curve element and the scalar form a valid signature for a message without revealing the scalar that includes information related to a private key used to generate the signature, thereby improving the security of the private key.

The client application 1220 may include an application (e.g., “app”), program, software, extension, or other component which is configured to facilitate communications with a custodial token platform 110 on a server, one or more nodes of a blockchain network 105, other user devices 1205, and other devices or systems. For example, the client application 1220 may be an application executable on the user device 1205, and the client application 1220 may be configured to receive data from a custodial token platform 110, transmit data to the custodial token platform 110, process such data, and cause presentation of such data to a user via a user interface component 1225. The client application 1220 may be an example of a wallet application, a wallet device, or both, and may be associated with a wallet address and may access or use a private key to sign messages to facilitate transfer of crypto tokens, messages, transactions, or the like via a blockchain distributed data store.

FIG. 13 shows a flowchart illustrating a method 1300 that supports publicly verifiable encrypted signatures in accordance with aspects of the present disclosure. The operations of the method 1300 may be implemented by a signing device or its components as described herein. For example, the operations of the method 1300 may be performed by a signing device as described with reference to FIGS. 1 through 9. In some examples, a signing device may execute a set of instructions to control the functional elements of the signing device to perform the described functions. Additionally, or alternatively, the signing device may perform aspects of the described functions using special-purpose hardware.

At 1305, the method may include generating a private key having a corresponding public key. The operations of 1305 may be performed in accordance with examples as disclosed herein. In some examples, aspects of the operations of 1305 may be performed by a key generation component 825 as described with reference to FIG. 8.

At 1310, the method may include cryptographically signing, using the private key, a message, wherein cryptographically signing the message outputs a signature comprising a random elliptic-curve element and a scalar. The operations of 1310 may be performed in accordance with examples as disclosed herein. In some examples, aspects of the operations of 1310 may be performed by a signature generation component 830 as described with reference to FIG. 8.

At 1315, the method may include encrypting the scalar using a publicly-verifiable encryption scheme and via an encryption key, wherein encrypting the scalar using the publicly-verifiable encryption scheme generates an encrypted scalar and a proof of encryption. The operations of 1315 may be performed in accordance with examples as disclosed herein. In some examples, aspects of the operations of 1315 may be performed by an encryption component 835 as described with reference to FIG. 8.

At 1320, the method may include transmitting, to a second device, the random elliptic-curve element, the encrypted scalar, and the proof of encryption ensuring that the random elliptic-curve element and the scalar form a valid signature for the message via a determination, by the second device, application of the scalar to a first public value equals a second public value. The operations of 1320 may be performed in accordance with examples as disclosed herein. In some examples, aspects of the operations of 1320 may be performed by a publicly verifiable information component 840 as described with reference to FIG. 8.

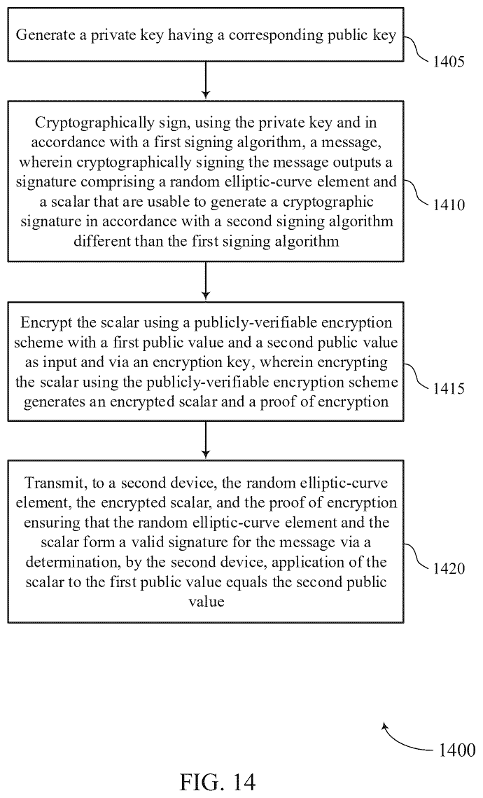

FIG. 14 shows a flowchart illustrating a method 1400 that supports publicly verifiable encrypted signatures in accordance with aspects of the present disclosure. The operations of the method 1400 may be implemented by a signing device or its components as described herein. For example, the operations of the method 1400 may be performed by a signing device as described with reference to FIGS. 1 through 9. In some examples, a signing device may execute a set of instructions to control the functional elements of the signing device to perform the described functions. Additionally, or alternatively, the signing device may perform aspects of the described functions using special-purpose hardware.

At 1405, the method may include generating a private key having a corresponding public key. The operations of 1405 may be performed in accordance with examples as disclosed herein. In some examples, aspects of the operations of 1405 may be performed by a key generation component 825 as described with reference to FIG. 8.

At 1410, the method may include cryptographically signing, using the private key and in accordance with a first signing algorithm, a message, wherein cryptographically signing the message outputs a signature comprising a random elliptic-curve element and a scalar that are usable to generate a cryptographic signature in accordance with a second signing algorithm different than the first signing algorithm. The operations of 1410 may be performed in accordance with examples as disclosed herein. In some examples, aspects of the operations of 1410 may be performed by a signature generation component 830 as described with reference to FIG. 8.

At 1415, the method may include encrypting the scalar using a publicly-verifiable encryption scheme and via an encryption key, wherein encrypting the scalar using the publicly-verifiable encryption scheme generates an encrypted scalar and a proof of encryption. The operations of 1415 may be performed in accordance with examples as disclosed herein. In some examples, aspects of the operations of 1415 may be performed by an encryption component 835 as described with reference to FIG. 8.

At 1420, the method may include transmitting, to a second device, the random elliptic-curve element, the encrypted scalar, and the proof of encryption ensuring that the random elliptic-curve element and the scalar form a valid signature for the message via a determination, by the second device, application of the scalar to a first public value equals a second public value. The operations of 1420 may be performed in accordance with examples as disclosed herein. In some examples, aspects of the operations of 1420 may be performed by a publicly verifiable information component 840 as described with reference to FIG. 8.

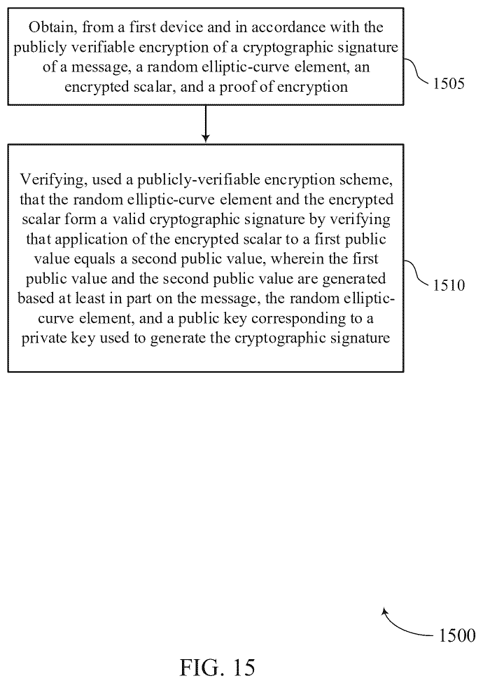

FIG. 15 shows a flowchart illustrating a method 1500 that supports publicly verifiable encrypted signatures in accordance with aspects of the present disclosure. The operations of the method 1500 may be implemented by a verifying device or its components as described herein. For example, the operations of the method 1500 may be performed by a verifying device as described with reference to FIGS. 1 through 6 and 10 through 12. In some examples, a verifying device may execute a set of instructions to control the functional elements of the verifying device to perform the described functions. Additionally, or alternatively, the verifying device may perform aspects of the described functions using special-purpose hardware.

At 1505, the method may include obtaining, from a first device and in accordance with the publicly verifiable encryption of a cryptographic signature of a message, a random elliptic-curve element, an encrypted scalar, and a proof of encryption. The operations of 1505 may be performed in accordance with examples as disclosed herein. In some examples, aspects of the operations of 1505 may be performed by a publicly verifiable information component 1125 as described with reference to FIG. 11.

At 1510, the method may include verifying, using a publicly-verifiable encryption scheme, that the random elliptic-curve element and the encrypted signature form a valid cryptographic signature by verifying that application of the encrypted scalar to a first public value equals a second public value, wherein the first public value and the second public value are generated based at least in part on the message, the random elliptic-curve element, and a public key corresponding to a private key used to generate the cryptographic signature. The operations of 1510 may be performed in accordance with examples as disclosed herein. In some examples, aspects of the operations of 1510 may be performed by a verification component 1130 as described with reference to FIG. 11.

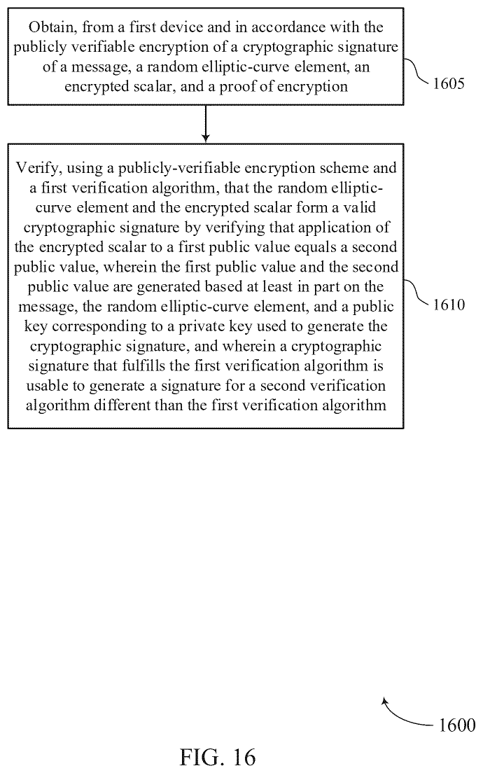

FIG. 16 shows a flowchart illustrating a method 1600 that supports publicly verifiable encrypted signatures in accordance with aspects of the present disclosure. The operations of the method 1600 may be implemented by a verifying device or its components as described herein. For example, the operations of the method 1600 may be performed by a verifying device as described with reference to FIGS. 1 through 6 and 10 through 12. In some examples, a verifying device may execute a set of instructions to control the functional elements of the verifying device to perform the described functions. Additionally, or alternatively, the verifying device may perform aspects of the described functions using special-purpose hardware.

At 1605, the method may include obtaining, from a first device and in accordance with the publicly verifiable encryption of a cryptographic signature of a message, a random elliptic-curve element, an encrypted scalar, and a proof of encryption. The operations of 1605 may be performed in accordance with examples as disclosed herein. In some examples, aspects of the operations of 1605 may be performed by a publicly verifiable information component 1125 as described with reference to FIG. 11.

At 1610, the method may include verifying, using a publicly-verifiable encryption scheme and a first verification algorithm, that the random elliptic-curve element and the encrypted signature form a valid cryptographic signature by verifying that application of the encrypted scalar to a first public value equals a second public value, wherein the first public value and the second public value are generated based at least in part on the message, the random elliptic-curve element, and a public key corresponding to a private key used to generate the cryptographic signature, and wherein a cryptographic signature that fulfills the first verification algorithm is usable to generate a signature for a second verification algorithm different than the first verification algorithm. The operations of 1610 may be performed in accordance with examples as disclosed herein. In some examples, aspects of the operations of 1610 may be performed by a verification component 1130 as described with reference to FIG. 11.

A method by an apparatus is described. The method may include generating a private key having a corresponding public key, cryptographically signing, using the private key, a message, wherein cryptographically signing the message outputs a signature comprising a random elliptic-curve element and a scalar, encrypting the scalar using a publicly-verifiable encryption scheme and via an encryption key, wherein encrypting the scalar using the publicly-verifiable encryption scheme generates an encrypted scalar and a proof of encryption, and transmitting, to a second device, the random elliptic-curve element, the encrypted scalar, and the proof of encryption ensuring that the random elliptic-curve element and the scalar form a valid signature for the message via a determination, by the second device, application of the scalar to a first public value equals a second public value.

An apparatus is described. The apparatus may include one or more memories storing processor executable code, and one or more processors coupled with the one or more memories. The one or more processors may individually or collectively be operable to execute the code to cause the apparatus to generate a private key having a corresponding public key, cryptographically sign, using the private key, a message, wherein cryptographically signing the message outputs a signature comprising a random elliptic-curve element and a scalar, encrypt the scalar using a publicly-verifiable encryption scheme and via an encryption key, wherein encrypting the scalar using the publicly-verifiable encryption scheme generates an encrypted scalar and a proof of encryption, and transmit, to a second device, the random elliptic-curve element, the encrypted scalar, and the proof of encryption ensuring that the random elliptic-curve element and the scalar form a valid signature for the message via a determination, by the second device, application of the scalar to a first public value equals a second public value.

Another apparatus is described. The apparatus may include means for generating a private key having a corresponding public key, means for cryptographically signing, using the private key, a message, wherein cryptographically signing the message outputs a signature comprising a random elliptic-curve element and a scalar, means for encrypting the scalar using a publicly-verifiable encryption scheme and via an encryption key, wherein encrypting the scalar using the publicly-verifiable encryption scheme generates an encrypted scalar and a proof of encryption, and means for transmitting, to a second device, the random elliptic-curve element, the encrypted scalar, and the proof of encryption ensuring that the random elliptic-curve element and the scalar form a valid signature for the message via a determination, by the second device, application of the scalar to a first public value equals a second public value.

A non-transitory computer-readable medium storing code is described. The code may include instructions executable by one or more processors to generate a private key having a corresponding public key, cryptographically sign, using the private key, a message, wherein cryptographically signing the message outputs a signature comprising a random elliptic-curve element and a scalar, encrypt the scalar using a publicly-verifiable encryption scheme and via an encryption key, wherein encrypting the scalar using the publicly-verifiable encryption scheme generates an encrypted scalar and a proof of encryption, and transmit, to a second device, the random elliptic-curve element, the encrypted scalar, and the proof of encryption ensuring that the random elliptic-curve element and the scalar form a valid signature for the message via a determination, by the second device, application of the scalar to a first public value equals a second public value.

In some examples of the method, apparatus, and non-transitory computer-readable medium described herein, cryptographically signing the message may include operations, features, means, or instructions for cryptographically signing the message in accordance with a first signing algorithm, wherein the random elliptic-curve element and the scalar output by cryptographically signing the message may be usable to generate a cryptographic signature in accordance with a second signing algorithm different than the first signing algorithm.

In some examples of the method, apparatus, and non-transitory computer-readable medium described herein, generating the private key having the corresponding public key may include operations, features, means, or instructions for sampling a random value to generate the private key and generating the public key corresponding to the random value via the private key and a generator function.

Some examples of the method, apparatus, and non-transitory computer-readable medium described herein may further include operations, features, means, or instructions for sampling a random value, wherein the random elliptic-curve element may be based at least in part on the random value and a generator function, generating a hash of a combination of the message, the random elliptic-curve element, and the public key, and generating the scalar via a summation of the random value and a product of the hash and the private key.

In some examples of the method, apparatus, and non-transitory computer-readable medium described herein, the first public value comprises the generator function and the second public value comprises a sum of the random elliptic-curve element and a product of the hash and the public key.

Some examples of the method, apparatus, and non-transitory computer-readable medium described herein may further include operations, features, means, or instructions for sampling a random value, wherein the random elliptic-curve element may be based at least in part on the random value and a generator function, determining a third intermediate value based at least in part on an x coordinate of the random elliptic-curve element, and generating the scalar as a summation divided by the random value, the summation being a summation of a hash of the message with a product of the third intermediate value and the private key.

In some examples of the method, apparatus, and non-transitory computer-readable medium described herein, the first public value and the second public value may be generated using the message and the random elliptic-curve element.

In some examples of the method, apparatus, and non-transitory computer-readable medium described herein, the first public value and the second public value may be unassociated with the scalar.

In some examples of the method, apparatus, and non-transitory computer-readable medium described herein, the first public value and the second public value comprise intermediate values that may be obtained via a portion of a verification algorithm performed by the second device.

In some examples of the method, apparatus, and non-transitory computer-readable medium described herein, the message comprises a blockchain transaction that may be cryptographically signed via the private key of a blockchain wallet.

A method by an apparatus is described. The method may include obtaining, from a first device and in accordance with the publicly verifiable encryption of a cryptographic signature of a message, a random elliptic-curve element, an encrypted scalar, and a proof of encryption and verifying, using a publicly-verifiable encryption scheme, that the random elliptic-curve element and the encrypted signature form a valid cryptographic signature by verifying that application of the encrypted scalar to a first public value equals a second public value, wherein: the first public value and the second public value are generated based at least in part on the message, the random elliptic-curve element, and a public key corresponding to a private key used to generate the cryptographic signature.

An apparatus is described. The apparatus may include one or more memories storing processor executable code, and one or more processors coupled with the one or more memories. The one or more processors may individually or collectively be operable to execute the code to cause the apparatus to obtain, from a first device and in accordance with the publicly verifiable encryption of a cryptographic signature of a message, a random elliptic-curve element, an encrypted scalar, and a proof of encryption and verify, using a publicly-verifiable encryption scheme, that the random elliptic-curve element and the encrypted signature form a valid cryptographic signature by verifying that application of the encrypted scalar to a first public value equals a second public value, wherein: the first public value and the second public value are generated based at least in part on the message, the random elliptic-curve element, and a public key corresponding to a private key used to generate the cryptographic signature.

Another apparatus is described. The apparatus may include means for obtaining, from a first device and in accordance with the publicly verifiable encryption of a cryptographic signature of a message, a random elliptic-curve element, an encrypted scalar, and a proof of encryption and means for verifying, using a publicly-verifiable encryption scheme, that the random elliptic-curve element and the encrypted signature form a valid cryptographic signature by verifying that application of the encrypted scalar to a first public value equals a second public value, wherein: the first public value and the second public value are generated based at least in part on the message, the random elliptic-curve element, and a public key corresponding to a private key used to generate the cryptographic signature.

A non-transitory computer-readable medium storing code is described. The code may include instructions executable by one or more processors to obtain, from a first device and in accordance with the publicly verifiable encryption of a cryptographic signature of a message, a random elliptic-curve element, an encrypted scalar, and a proof of encryption and verify, using a publicly-verifiable encryption scheme, that the random elliptic-curve element and the encrypted signature form a valid cryptographic signature by verifying that application of the encrypted scalar to a first public value equals a second public value, wherein: the first public value and the second public value are generated based at least in part on the message, the random elliptic-curve element, and a public key corresponding to a private key used to generate the cryptographic signature.

In some examples of the method, apparatus, and non-transitory computer-readable medium described herein, verifying the cryptographic signature may include operations, features, means, or instructions for verifying the cryptographic signature in accordance with a first verification algorithm, wherein a cryptographic signature that fulfills the first verification algorithm may be usable to generate a signature for a second verification algorithm different than the first verification algorithm.

In some examples of the method, apparatus, and non-transitory computer-readable medium described herein, verifying the cryptographic signature may include operations, features, means, or instructions for generating the first public value using a generator function, generating the second public value using a hash of the message, the random elliptic-curve element, and the public key, and verifying that a product of the encrypted scalar and the first public value corresponds to the second public value.

Some examples of the method, apparatus, and non-transitory computer-readable medium described herein may further include operations, features, means, or instructions for determining a third intermediate value based at least in part on an x coordinate of the random elliptic-curve element.

In some examples of the method, apparatus, and non-transitory computer-readable medium described herein, verifying the cryptographic signature may include operations, features, means, or instructions for verifying that a product of the encrypted scalar and the random elliptic-curve element corresponds to the summation of the first product and the second product.

In some examples of the method, apparatus, and non-transitory computer-readable medium described herein, the first public value and the second public value may be generated using the message and the random elliptic-curve element.

In some examples of the method, apparatus, and non-transitory computer-readable medium described herein, the first public value and the second public value may be unassociated with the scalar.

In some examples of the method, apparatus, and non-transitory computer-readable medium described herein, the first public value and the second public value comprise intermediate values that may be obtained via a portion of a verification algorithm and without the scalar and verifying the cryptographic signature may be in accordance with the verification algorithm.

In some examples of the method, apparatus, and non-transitory computer-readable medium described herein, the message comprises a blockchain transaction that may be cryptographically signed via the private key of a blockchain wallet.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method of publicly verifiable encryption, comprising:
generating a private key having a corresponding public key;
cryptographically signing, using the private key, a message, wherein cryptographically signing the message outputs a signature comprising a random elliptic-curve element and a scalar;
encrypting the scalar using a publicly-verifiable encryption scheme with a first public value and a second public value as inputs and via an encryption key, wherein encrypting the scalar using the publicly-verifiable encryption scheme generates an encrypted scalar and a proof of encryption; and
transmitting, to a second device, the random elliptic-curve element, the encrypted scalar, and the proof of encryption ensuring that the random elliptic-curve element and the scalar form a valid signature for the message via a determination, by the second device, application of the scalar to the first public value equals the second public value.

2. The method of claim 1, wherein cryptographically signing the message comprises:
cryptographically signing the message in accordance with a first signing algorithm, wherein the random elliptic-curve element and the scalar output by cryptographically signing the message are usable to generate a cryptographic signature in accordance with a second signing algorithm different than the first signing algorithm.

3. The method of claim 1, wherein generating the private key having the corresponding public key comprises:
sampling a random value to generate the private key; and
generating the public key corresponding to the random value via the private key and a generator function.

4. The method of claim 1, further comprising:
sampling a random value, wherein the random elliptic-curve element is based at least in part on the random value and a generator function;
generating a hash of a combination of the message, the random elliptic-curve element, and the public key; and
generating the scalar via a summation of the random value and a product of the hash and the private key.

5. The method of claim 4, wherein the first public value comprises the generator function and the second public value comprises a sum of the random elliptic-curve element and a product of the hash and the public key.

6. The method of claim 1, further comprising:
sampling a random value, wherein the random elliptic-curve element is based at least in part on the random value and a generator function;
determining a third intermediate value based at least in part on an x coordinate of the random elliptic-curve element; and
generating the scalar as a summation divided by the random value, the summation being a summation of a hash of the message with a product of the third intermediate value and the private key.

7. The method of claim 1, wherein the first public value and the second public value are generated using the message and the random elliptic-curve element.

8. The method of claim 1, wherein the first public value and the second public value are unassociated with the scalar.

9. The method of claim 1, wherein the first public value and the second public value comprise intermediate values that are obtained via a portion of a verification algorithm performed by the second device.

10. The method of claim 1, wherein the message comprises a blockchain transaction that is cryptographically signed via the private key of a blockchain wallet.

11. The method of claim 1, wherein the private key comprises a share of a plurality of key shares, and wherein the signature comprises a partial signature.

12. A method of publicly verifiable encryption, comprising:
obtaining, from a first device and in accordance with the publicly verifiable encryption of a cryptographic signature of a message, a random elliptic-curve element, an encrypted scalar, and a proof of encryption; and
verifying, using a publicly-verifiable encryption scheme, that the random elliptic-curve element and the encrypted scalar form a valid cryptographic signature by verifying that application of the encrypted scalar to a first public value equals a second public value, wherein: the first public value and the second public value are generated based at least in part on the message, the random elliptic-curve element, and a public key corresponding to a private key used to generate the cryptographic signature.

13. The method of claim 12, wherein verifying the cryptographic signature comprises:
verifying the cryptographic signature in accordance with a first verification algorithm, wherein a cryptographic signature that fulfills the first verification algorithm is usable to generate a signature for a second verification algorithm different from the first verification algorithm.

14. The method of claim 12, wherein verifying the cryptographic signature comprises:
generating the first public value using a generator function;
generating the second public value using a hash of the message, the random elliptic-curve element, and the public key; and
verifying that a product of the encrypted scalar and the first public value corresponds to the second public value.

15. The method of claim 12, further comprising:
determining a third intermediate value based at least in part on an x coordinate of the random elliptic-curve element.

16. The method of claim 15, wherein the first public value comprises the random elliptic-curve element, and wherein the second public value comprises a summation of a first product of a hash of the message and a generator function and a second product of the third intermediate value and the public key, and wherein verifying the cryptographic signature comprises:
verifying that a product of the encrypted scalar and the random elliptic-curve element corresponds to the summation of the first product and the second product.

17. The method of claim 12, wherein the first public value and the second public value are generated using the message and the random elliptic-curve element.

18. The method of claim 12, wherein the first public value and the second public value are unassociated with the scalar.

19. The method of claim 12, wherein the private key comprises a share of a plurality of key shares, and wherein the signature comprises a partial signature.

20. An apparatus, comprising:
one or more memories storing processor-executable code; and
one or more processors coupled with the one or more memories and individually or collectively operable to execute the code to cause the apparatus to:
generate a private key having a corresponding public key;
cryptographically sign, using the private key and in accordance with a first signing algorithm, a message, wherein cryptographically signing the message outputs a signature comprising a random elliptic-curve element and a scalar, and wherein the random elliptic-curve element and the scalar are usable to generate a cryptographic signature in accordance with a second signing algorithm different than the first signing algorithm;
encrypt the scalar using a publicly-verifiable encryption scheme with a first public value and a second public value as inputs and via an encryption key, wherein encrypting the scalar using the publicly-verifiable encryption scheme generates an encrypted scalar and a proof of encryption; and
transmit, to a second device, the random elliptic-curve element, the encrypted scalar, and the proof of encryption ensuring that the random elliptic-curve element and the scalar form a valid signature for the message via a determination, by the second device, application of the scalar to the first public value equals the second public value.
